(19) United States
(12) Patent Application Publication
(10) Pub. No.: US 2013/0153059 A1
(43) Pub. Date: Jun. 20, 2013

(54) HOLDER FOR AT LEAST ONE ELECTRODE IN AN EXHAUST-GAS LINE AND APPARATUS HAVING AT LEAST ONE HOLDER

(71) Applicant: EMITEC GESELLSCHAFT FUER EMISSIONSTECHNOLOGIE MBH, LOHMAR (DE)

(72) Inventors: JAN HODGSON, TROISDORF (DE); CHRISTIAN VORSMANN, KOELN (DE); ROLF BRUECK, BERGISCH GLADBACH (DE)

(73) Assignee: EMITEC GESELLSCHAFT FUER EMISSIONSTECHNOLOGIE MBH, LOHMAR (DE)

(21) Appl. No.: 13/765,868

(22) Filed: Feb. 13, 2013

Related U.S. Application Data
(63) Continuation of application No. PCT/EP2011/063894, filed on Aug. 12, 2011.

(30) Foreign Application Priority Data
Aug. 13, 2010 (DE) 10 2010 034 250.5

(51) Int. Cl. F01N 13/00; F16L 55/00

(52) U.S. Cl. CPC F01N 13/008; F16L 55/00
USPC 137/544; 138/108

(57) ABSTRACT

A holder for at least one electrode, in particular a discharge electrode which is suitable for producing a corona discharge, in an exhaust-gas line, includes a body through which an exhaust gas can flow and at least one electric contact for the at least one electrode. Preferably, the at least one electric contact is integrated into the body. An apparatus for fixing at least one electric electrode in an exhaust-gas line is also proposed. The apparatus has at least one such holder and the apparatus has a particle separator disposed downstream in exhaust gas flow direction.

### CROSS-REFERENCE TO RELATED APPLICATION

This is a continuation, under 35 U.S.C. §120, of copending International Application No. PCT/EP2011/063894, filed Aug. 12, 2011, which designated the United States; this application also claims the priority, under 35 U.S.C. §119, of German Patent Application DE 10 2010 034 250.5, filed Aug. 13, 2010; the prior applications are herewith incorporated by reference in their entirety.

### BACKGROUND OF THE INVENTION

### Field of the Invention

The present invention relates to a holder for at least one electrode in an exhaust-gas line, in particular for providing an electric field with which soot particles contained in the exhaust gas can be charged, agglomerated and/or removed. The present invention also relates to an apparatus having at least one holder.

A large number of different concepts for removing soot particles from exhaust gases from mobile internal combustion engines have already been discussed. In addition to alternately closed wall-flow filters, open partial-flow filters, gravity separators, etc., there have also already been proposals for systems in which the particles in the exhaust gas are electrically charged and then deposited with the aid of electrostatic attraction forces. Those systems are known, in particular, by the name “electrostatic filters” or “electrostatic precipitators.”

Thus, there are frequent proposals to provide such electrostatic precipitators with (a plurality of) discharge electrodes and collector electrodes, which are positioned in the exhaust-gas line. In that case, a central discharge electrode, for example, which runs approximately centrally through the exhaust-gas line, and a surrounding circumferential surface of the exhaust-gas line as a collector electrode, are used to form a capacitor. Through the use of that configuration of the discharge electrode and the collector electrode, an electric field is formed transversely to the flow direction of the exhaust gas and it is possible to operate the discharge electrode at a high voltage in the region of about 15 kV, for example. As a result, it is possible, in particular, for corona discharges to form, charging the particles flowing through the electric field with the exhaust gas in a unipolar manner. Due to that charging, the particles migrate to the collector electrode by virtue of electrostatic coulomb forces.

In addition to systems in which the exhaust-gas line is embodied as a collector electrode, systems in which the collector electrode is constructed as a wire mesh, for example, are also known. In that case, particles are accumulated on the wire mesh for the purpose of possibly combining those particles with other particles in order to achieve agglomeration in that way. The exhaust gas flowing through the mesh then entrains the larger particle agglomerates again and carries them to traditional filter systems.

Even if the systems described above have previously proven suitable for treating soot particles, at least in tests, implementing that concept for regular operation in motor vehicles still represents a major technical challenge. That applies particularly with regard to the large fluctuations in soot loading in the exhaust gas, which can be very high with respect to time. The desired capacity for retrofitting such a system to existing exhaust systems likewise still represents a major problem. In particular, surges in the amount of exhaust gas in the exhaust system of motor vehicles often occur, whereas they do not occur with stationary internal combustion engines used for power generation, for example. Furthermore, exhaust systems are subject to mechanical loads due to irregularities in the ground, for example. Moreover, it must be taken into account that, given the increased performance and effectiveness of such exhaust systems, a (periodic and/or continuous) regeneration of the filter systems with respect to the removal of soot particles is also required, during which process the soot is converted into gaseous components.

Known processes for regenerating filter systems include not only intermittent regeneration by brief heating, i.e. burning the soot (catalytically assisted conversion by oxidation) but also conversion of soot through the use of nitrogen dioxide (NO₂). The advantage of continuous regeneration with nitrogen dioxide is that, the conversion of soot can take place at significantly lower temperatures (in particular less than 250° C.). For that reason, continuous regeneration is preferred in many applications. However, that leads to the problem of having to ensure that the nitrogen dioxide in the exhaust gas comes into contact to a sufficient extent with the deposited soot particles.

In that context too, there are technical difficulties in achieving sustained operation of such exhaust systems in motor vehicles, wherein the differing loads on the internal combustion engines lead to differing exhaust-gas flows, exhaust-gas compositions and/or temperatures.

Moreover, it must be taken into account that the components used for such a soot removal system, including those, in particular, which can be produced economically as part of a series production process, should be as simple as possible. In addition, it must be taken into account, precisely when constructing the electrodes, that it may be necessary to position the electrodes in alignment in the exhaust-gas line, in particular in such a way that an undesirably high backpressure or unwanted swirling of the exhaust gas in the region of the electrode does not occur.

### SUMMARY OF THE INVENTION

It is accordingly an object of the invention to provide a holder for at least one electrode in an exhaust-gas line and an apparatus having at least one holder, which overcome the hereinafore-mentioned disadvantages and at least partially mitigate the highlighted problems of the heretofore-known holders and apparatuses of this general type. In particular, the intention is to indicate a holder for at least one electrode which allows precise alignment of the electrode in the exhaust-gas flow. Moreover, it should be possible to provide the holder by technically simple measures and the holder should withstand the changing conditions in the exhaust system of a motor vehicle on a long-term basis.

With the foregoing and other objects in view there is provided, in accordance with the invention, a holder for at least one electrode, in particular for at least one discharge electrode suitable for producing a corona discharge, in an exhaust-gas line. The holder comprises a body through which an exhaust gas can flow, and at least one electric contact for the at least one electrode.

In accordance with another advantageous feature of the invention, the at least one electrode is a discharge electrode suitable for producing a corona discharge, the body through which the flow can occur has channels and holds the at least one electrode, and the at least one electric contact is integrated into the body.

Where an electrode is mentioned below, a discharge electrode suitable for producing a corona discharge is intended, in particular.

It is preferred if the holder is used to fix or mount a plurality (or even a multiplicity) of electrodes in the exhaust-gas line. For this purpose, a body through which the flow can occur is provided, on which the at least one electrode is disposed. The body through which the flow can occur is embodied in such a way that the exhaust gas can flow through the body without a significant pressure loss. In order to achieve this, suitable openings, channels or the like are provided, through which the exhaust gas can be passed. In particular, channels with a channel density of at least 150 cpsi (channels per square inch), or even 300 cpsi, are preferred. In this context, the term “channel” should be taken to mean an opening through which the flow can occur and the length of which in the flow direction is greater than the cross section thereof.

In this case, the electrodes preferably extend in the flow direction of the exhaust gas through the body through which the flow can occur and/or, particularly preferably, in such a way as to project on one side beyond the body through which the flow can occur. In particular, the electrode is constructed as a bar electrode, the end of which has a tip with a radius of curvature which is suitable for producing a corona discharge when a corresponding voltage is applied. It is furthermore preferred in this case if the flow through the body through which the flow can occur can be substantially laminar thus, in particular, ensuring a specific flow of the exhaust gas along the electrode. For this purpose, the electrodes can project perpendicularly from one end face of the body through which the flow can occur. That end face is preferably disposed transversely to the flow direction of the exhaust gas. In addition to influencing the flow or allowing flow, the holder furthermore has the function of making electrical contact with the at least one electrode. For this purpose, electric conductors are formed in or on the body through which the flow can occur, thus providing electric contact from the exhaust-gas line to the at least one electrode. Electric contact can be formed by printed conductors, electrically conductive materials, cables, etc. In this context, it is preferred if the electric contact is integrated or incorporated at least partially into the holder. For this purpose, it is also possible to provide electric insulators in order to ensure a targeted supply of electric current to the electrode. In particular, the electric contact is constructed in such a way that a high voltage (e.g. above 1000 volts) with, at the same time, a low current (e.g. below 0.1 ampere) can be achieved.

In particular, the electric contact is formed by the material of the body. This means that an electric potential applied to the body is also applied to the discharge electrode. This can be achieved by manufacturing the body from an electrically conductive material, in particular metal, and by the body as a whole being at an electric potential. It is furthermore possible for the electrically conductive body to be electrically segmented by insulators and for defined regions of the body to be at an electric potential. It is additionally preferred if a channel wall of a channel serves as an electric contact and is thus electrically isolated from the rest of the body, there being an electrically conductive connection to a terminal outside the exhaust-gas line.

Provision can furthermore be made for the electric contact to be a separate component which is integrated into the body during the production of the latter. Thus, for example, at least one cable can be integrated into the body.

In accordance with a further preferred feature of the invention, the body through which the flow can occur has at least one housing and at least one metallic honeycomb structure, wherein the at least one electric contact is formed through the at least one housing. The housing is constructed in the manner of a cylindrical jacketing tube, for example. A metallic honeycomb structure can be provided within this housing. The honeycomb structure is formed by a plurality of at least partially structured metallic layers, for example. In this case, the honeycomb structure forms channels that run substantially parallel to one another, through which the exhaust gas can flow with little pressure loss. In the case where a plurality of electrodes is provided, which are provided separately with an electric contact if appropriate, it is also possible for a plurality of housing parts to be provided for each different electric contact. These housing parts are then electrically isolated from one another, if appropriate. The production of such bodies through which a flow can occur has already become established, especially in the automotive sector, and therefore such honeycomb structures for fixing the at least one electrode can in this case be produced by measures that are simple in terms of production engineering. Moreover, it is possible in this way to ensure that substantially laminar flow is established. In this case, the electric contact, which is brought into contact with a power supply or voltage supply at one end, is passed (in an insulated manner) through the exhaust-gas line and the at least one housing.

In accordance with an added feature of the invention, the body through which the flow can occur has a plurality of electrodes and at least one distributor, wherein the at least one distributor makes electric contact with a plurality of electrodes. In this case, the electric contact is connected to an electrically conductive distributor which is an integral part of the body through which the flow can occur. The distributor can be embodied as a separate component, e.g. in the manner of a cable harness, a printed conductor structure or the like. The distributor serves to distribute the current supplied by the electric contact (uniformly) to the plurality of electrodes. Through the appropriate embodiment of the distributor, it is thus possible to set a predetermined electric field without problems by using a plurality of electrodes. In particular, the power supply to the body through which the flow can occur or to the plurality of electrodes is simplified in this way.

In this case, the electric contact or distributor can be fixed in the body through which the flow can occur by brazing, soldering or welding, for example.

In accordance with an additional feature of the invention, the body through which the flow can occur has at least one first channel having a channel cross section and at least one second channel having an electrode cross section. In this embodiment, it is preferred if the body through which the flow can occur is in the form of a honeycomb structure, wherein channels of different channel cross sections are provided. While first channels are provided only to carry the exhaust gas through, second channels are provided for the purpose of accommodating the at least one electrode. In this case, the second channels have a channel cross section which corresponds substantially to the electrode cross section, and it is therefore possible for the electrode to be disposed at least partially within the second channels and substantially to close the channel cross section thereof. In this way, it is possible to form an electric contact through the periphery of the electrode and to form a durable connection, e.g. through the use of brazing, soldering and/or welding.

In accordance with yet another advantageous feature of the invention, the body through which the flow can occur is electrically segmented, wherein the segments are at least partially isolated from one another. In particular, where an electric field with varying properties is desired, in which, for example, partial areas in the exhaust-gas line are to be provided (temporarily) with a variable electric field, this construction is preferred. In this case, therefore, it is ensured that a supply of electrical current to the plurality of electrodes can be implemented separately and independently of each other. Thus, the number of electrodes forming the electric field can be varied in accordance with requirements, if appropriate. A supply of electrical current with different parameters simultaneously to different electrodes is also made possible, if appropriate. In order to avoid the individual electrodes being influenced, the current conduction structures or electric contact or distributor are segmented and electrically isolated from one another. The individual segments can be embodied with a separate power supply and/or control.

With the objects of the invention in view, there is also provided an apparatus for fixing at least one electric electrode in an exhaust-gas line. The apparatus comprises at least one holder according to the invention and a particle separator disposed downstream in flow direction of the exhaust gas. Thus, an electric field is built up, in particular, between the at least one electric electrode and the downstream particle separator in the flow direction. Consequently, it is possible, through the use of the electric electrode, to provide the soot particles contained in the exhaust gas with an electric charge, thereby increasing their tendency to be precipitated toward the particle separator. Moreover, it is possible for the particles to agglomerate due to the electric field and thus for even the smallest soot particles to be deposited in the downstream particle separator and finally to be converted.

The particulate trap is, in particular, a so-called open partial-flow filter, in which the flow channels are not completely closed. Instead, the particulate trap is formed by a metallic nonwoven and metallic corrugated layers, in which openings, guide structures, etc. are provided. In this case, the guide structures form flow constrictions in the flow passages, thus increasing the dwell time or probability of collision for soot particles within the particulate trap. In this context, attention is drawn to the known patent publications of the Applicant of the instant application, to which reference can be made for more detailed characterization of the particulate trap and/or the regeneration thereof. In particular, the description of the following documents is incorporated fully herein by reference for this purpose: International Publication No. WO 2001/80978, corresponding to U.S. Pat. No. 8,066,952; International Publication No. WO 2002/00326, corresponding to U.S. Pat. No. 6,712,884; International Publication No. WO 2005/099867, corresponding to U.S. Pat. No. 7,959,868; International Publication No. WO 2005/066469, corresponding to U.S. Patent Application Publication No. 2007/006556; International Publication No. WO 2006/136431, corresponding to U.S. Patent Application Publication No. 2008/0155967; and International Publication No. WO 2007/140932, corresponding to U.S. Pat. No. 8,066,787.

Regeneration of such a particulate trap of this kind is preferably performed continuously on the basis of the CRT method. For this purpose, an oxidation catalytic converter, for example, can be disposed upstream of the apparatus. In the catalytic converter (inter alia) nitric oxide is oxidized to give nitrogen dioxide, which then reacts with the soot in the particulate trap. It is furthermore also possible for an oxidizing coating of this kind to be implemented in the particulate trap itself, either in one zone thereof or, alternatively, in all regions of the particulate trap.

In accordance with another expedient feature of the invention, a plurality of holders is provided. These holders are preferably disposed in series in the flow direction of the exhaust gas. In this case, the plurality of holders can influence each other with regard to their effect on the flow behavior of the exhaust gas and/or the formation of the electric field. In this case, it is also possible, if appropriate, for the electrodes of a first holder to at least partially penetrate the following, second holder.

In many applications, it is envisaged that the body completely spans a line cross section of the exhaust-gas line. In other words, this means, in particular, that the exhaust gas cannot flow past the body on the outside but flows through the interior of the body.

In accordance with a further feature of the invention, however, it is also possible to provide for the at least one holder to only partially span the line cross section of the exhaust-gas line. Thus, for example, the holder can be embodied with an annular gap toward the exhaust-gas line. Precisely in the case of the formation of a plurality of holders in series, it is possible once again overall to span the entire line cross section of the exhaust-gas line. The situation in this case can be such, for example, that initially only a central circular segment of the line section is filled by the holder, while following regions are embodied with concentric annular holders.

In accordance with a concomitant feature of the invention, the at least one holder is embodied so as to be vibrationally sensitive to exhaust-gas pulsations. This means, in particular, that the holder is mounted in the exhaust-gas line in such a way that it is excited to vibrate by the exhaust-gas pulsation caused by the combustion processes in the engine of the motor vehicle. It is possible in this case to embody the holder in such a way that axial and/or radial vibration of the holder and/or of the discharge electrode is possible. To this extent, correspondingly flexible or “soft” mountings should be provided in this case. In this way, depositions of soot, for example, on the holder and/or on the discharge electrodes during operation are repeatedly released again, and therefore, in particular, the risk of electric short-circuits in the region of the holder can be significantly reduced in this case.

Other features which are considered as characteristic for the invention are set forth in the appended claims, noting that the features presented individually in the claims can be combined in any technologically meaningful way and give rise to further embodiments of the invention.

Although the invention is illustrated and described herein as embodied in a holder for at least one electrode in an exhaust-gas line and an apparatus having at least one holder, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of an exhaust-gas line with a first illustrative embodiment of an apparatus having an electrode holder and a downstream particle separator; and

FIG. 2 is a cross-sectional view of an illustrative embodiment of a holder.

### DETAILED DESCRIPTION OF THE INVENTION

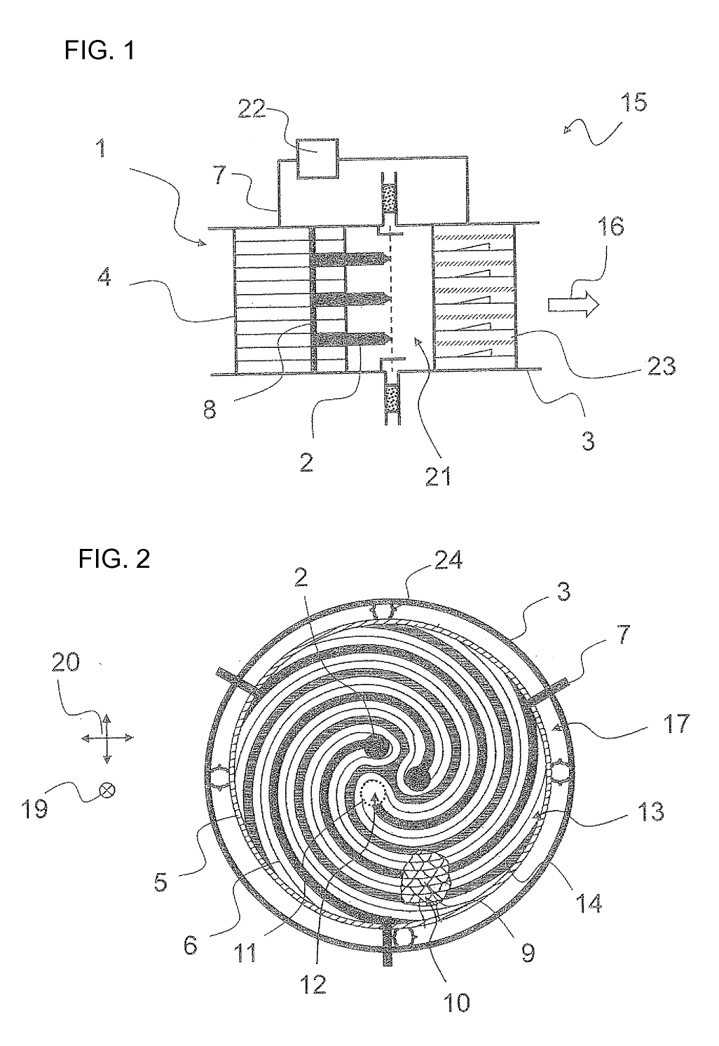

Referring now in detail to the figures of the drawings, which show particularly preferred embodiments to which the invention is not restricted, and first, particularly, to FIG. 1 thereof, there is seen a longitudinal section through an apparatus 15 for fixing a plurality of electric electrodes 2 in an exhaust-gas line 3. A holder 1 having a body 4 through which an exhaust gas can flow is first of all provided, as seen in an exhaust gas flow direction 16. The body 4 through which a flow can occur has a multiplicity of channels running parallel to one another. A plurality of electrodes 2 is disposed in such a manner as to be distributed over the cross section on the rear side of the body 4 through which the flow can occur. The apparatus 15 furthermore has an electric power supply 22, which provides an electric current flow to the electrodes 2 through an electric contact 7 and a distributor 8. An electric field 21 is then formed downstream of the body 4 through which the flow can occur, in the flow direction 16, starting from the electrodes 2. In this configuration, a potential is formed between the body 4 through which the flow can occur and a downstream particle separator 23, which is likewise positioned in the exhaust-gas line 3. In particular, the particle separator 23 is constructed in the manner of a metallic, open partial-flow filter.

FIG. 2 shows a cross section of a suitable electrode holder, likewise in a diagrammatic manner. The substantially tubular exhaust-gas line 3, which forms a substantially round line cross section 17, is shown. The body 4, through which the flow can occur, includes a housing 5 and a metallic structure 6 and is formed at a spacing relative to the exhaust-gas line 3. In this case, the body 4 through which the flow can occur forms three segments 13, which likewise have an electric contact 7, allowing a supply of electric current to the three centrally indicated electrodes 2. The individual segments are formed by smooth and structured metal foils, with the result that channels through which the exhaust gas can flow are formed. The segments 13 are furthermore spaced apart from one another through the use of electric insulation. It should be noted that the proportion of channels through which the flow can occur relative to the electrically insulated partial areas of the body through which the flow can occur is generally significantly greater than illustrated therein.

Consequently, a multiplicity of first channels 9, having a predetermined channel cross section 10, is obtained in this case. Moreover, (three) second channels 11 are provided in this case, serving to accommodate the three electrodes 2. The second channels 11 substantially form an electrode cross section 12.

Moreover, FIG. 2 illustrates the fact that the housing 5 with the honeycomb structure 6 is embodied with mounts 24, making the holder vibrationally sensitive to exhaust-gas pulsation. Thus, in particular, a relative motion of the holder with respect to the exhaust-gas line 3 in the direction of a radius 20 or an axis 19 is made possible.

The present invention thus at least partially solves the problems explained with reference to the prior art. In particular, a holder for at least one electrode (discharge electrode for producing a corona discharge) is indicated which allows precise alignment of the electrode in the exhaust-gas flow. Moreover, this holder can be provided by technically simple measures and can withstand the changing conditions in the exhaust system of a motor vehicle on a sustained basis.

1. A holder for at least one electrode in an exhaust-gas line, the holder comprising:
a body through which an exhaust gas can flow; and
at least one electric contact for the at least one electrode in the exhaust-gas line.

2. The holder according to claim 1, wherein:
said at least one electrode is a discharge electrode suitable for producing a corona discharge;
said body through which the flow can occur has channels and holds the at least one electrode; and
said at least one electric contact is integrated into said body.

3. The holder according to claim 1, wherein:
said body through which the flow can occur has at least one housing and at least one metallic honeycomb structure; and
said at least one electric contact passes through said at least one housing.

4. The holder according to claim 1, wherein said body through which the flow can occur has at least one distributor, and said at least one distributor makes electric contact with a plurality of the electrodes in said body.

5. The holder according to claim 1, wherein said body through which the flow can occur has at least one first channel with a channel cross section and at least one second channel with an electrode cross section.

6. The holder according to claim 1, wherein said body through which the flow can occur is electrically segmented and has segments being at least partially isolated from one another.

7. An apparatus for fixing at least one electric electrode in an exhaust-gas line, the apparatus comprising:
at least one holder according to claim 1; and
a particle separator disposed downstream of said at least one holder in an exhaust gas flow direction.

8. The apparatus according to claim 7, wherein said at least one holder is a plurality of holders.

9. The apparatus according to claim 7, wherein said at least one holder only partially spans a line cross section of the exhaust-gas line.

10. The apparatus according to claim 7, in which the at least one holder is embodied so as to be vibrationally sensitive to exhaust-gas pulsations.
